(19) United States
(12) Patent Application Publication
(10) Pub. No.: US 2009/0222123 A1
(43) Pub. Date: Sep. 3, 2009

(54) Method and system for scheduling a set of events in real time

(75) Inventors: Kevin Nevills, Marlboro, NJ (US); Ashok Erramilli, Holmdel, NJ (US); Vishnu Erramilli, Red Bank, NJ (US); Srinivas Netrakanti, Edmonton (CA); Erwin Paes, Edmonton (CA); Robert Stawicki, Bridgewater, NJ (US)

Correspondence Address: WILLIAM L BOTJER, P O BOX 478, CENTER MORICHES, NY, 11934, US

(73) Assignee: OPTESSA, INC.

(21) Appl. No.: 12/291,238

(22) Filed: Nov. 7, 2008

Related U.S. Application Data
(60) Provisional application No. 61/002,232, filed on Nov. 7, 2007.

(51) Int. Cl. G06F 19/00

(52) U.S. Cl. 700/104; 700/105

(57) ABSTRACT

A method and system for generating/regenerating a schedule of a set of events associated with at least one process in a manufacturing plant in real time. The schedule is generated/regenerated on the basis of the occurrence of one or more events associated with various processes in real time. The occurrence of each of the events is monitored continuously. Thereafter, the occurrence of the monitored events is predicted for one or more predefined instances of time. The schedule is optimized on the basis of the predicted occurrences of the monitored events to generate/regenerate the schedule. The optimized schedule may be used to control one or more automatons.

### REFERENCE TO RELATED APPLICATIONS

This application claims priority of U.S. Provisional Patent application Ser. No. 61/002,232 filed Nov. 7, 2007 and titled “Optimization Based on Real-Time Event Tracking”.

### BACKGROUND

The present invention relates to generating a schedule of a set of events in a manufacturing plant. More specifically, it relates to an optimized generation and regeneration of a schedule in real time, based on the tracking of one or more events in the manufacturing plant.

Typically, a manufacturing plant is set up to manufacture products. Examples of a manufacturing plant include, but are not limited to, an automobile manufacturing plant, a semiconductor chip manufacturing plant, a steel plant, and a food processing plant. To manufacture products in the manufacturing plant, one or more processes are carried out on objects, hereinafter referred to as jobs. Examples of the processes in an automobile manufacturing plant include, but are not limited to, welding, paint, storing, retrieving and assembling. Similarly, examples of the processes carried out in the semiconductor chip manufacturing plant include, but are not limited to, etching, doping and material handling of wafers. The processes may be carried out on a job in a specific order. For example, paint may be carried out on a job only after welding has been performed on the job.

Each process takes a predefined amount of time for completion, hereinafter referred to as process time. Based on the process time, events associated with the processes occur at different instances of time. Examples of events include, but are not limited to, ‘weld in’ and ‘weld out’ associated with the welding process. Therefore, if the welding process has a process time of two hours, then ‘weld out’ occurs two hours after the occurrence of ‘weld in’. The schedule of the set of events is based on the process time of each of the processes and the order of the processes in the manufacturing plant. The set of events is associated with at least one process.

Therefore, a manufacturing plant executes multiple processes on a wide variety of jobs, with each stage of production of the job requiring one or more resources. The cost of manufacturing a job depends on the extent to which these resources are used. One of the targets of the manufacturing plant is to maximize resource utilization. This target of maximizing the resource utilization is accomplished by generating a schedule for each job. A simplified version of a schedule is a sequence that specifies the order in which a resource processes jobs without assigning a time. Hereinafter, the term “schedule” is used interchangeably with “sequence”, as in principle, given one, the other can be generated.

Examples of manufacturing resources whose usage must be maximized include final assembly lines, paint shops, weld or body shops, tools in machine shops, cluster tools in semiconductor manufacturing, etc. Other examples of manufacturing resources include automata, such as Automated Storage and Retrieval Systems (ASRS), are used to store and forward painted automobile units between a paint line and an assembly line; Automation tools/devices (automata) such as robots, Automated Guided Vehicles (AGVs), conveyors, automated feeders and Automated Material Handling Systems (AMHS) can also be also used to eliminate manual processes in manufacturing plants. The automation tools/devices use various components to automate the processes in a manufacturing industry. Some examples of the components used in automation tools/devices include controllers along with sensors, microprocessors, wireless sensor networks, and warehouse control systems. Examples of the controllers include, but are not limited to, Programmable Logic Controllers (PLCs).

In the current state of the art, optimized scheduling is done ‘off line’ or at a time (hours or days) before production because of the time taken to execute the optimization. While such optimized scheduling can render several benefits to manufacturing plants, off-line scheduling is limited to responding to the predefined or expected events and not to unplanned events occurring in real time. Examples of the unplanned events include, but are not limited to, a breakdown of a tool in a shop in the manufacturing plant and a failure of a supplier to deliver required parts in time. Such real time unplanned events may disrupt the schedule making it infeasible.

To account for such disruptions, ‘on-line’ scheduling (or rescheduling of an existing off-line schedule) in real time is necessary. In the current state of the art, this function is supported within controllers without any optimization. In particular, the controllers associated with the automaton can generate the schedule over a short time duration covering only a limited number of events which limits the quality of the resulting schedule. The time duration for which the schedule is generated is hereinafter referred to as schedule horizon’. A scheduler that only looks ahead one next step a time can make decisions that cause severe problems at a later instant of time.

In light of the discussion above, there is a need for a method and system which optimally regenerates the schedule considering the real time events without requiring manual intervention and also for a long schedule horizon covering a larger number of the events. Such a system will combine the benefits of optimal off-line scheduling while ensuring its feasibility with real time disruptions.

### SUMMARY

An object of the invention is to increase efficiency in generating and regenerating a schedule of a set of events in a manufacturing plant.

Another object of the invention is to regenerate a schedule of a set of events in real time in response to one or more events occurring in real time without the need of manual intervention in a manufacturing plant.

To achieve the objectives mentioned above, the invention provides a method and system for regenerating a schedule of a set of events in a manufacturing plant in real time. The set of events are associated with at least one process of one or more processes of the manufacturing plant. Each of the processes has one or more associated events.

The process is carried out according to a reference schedule of the set of events based on a predefined state of all of the events. To check whether the reference schedule is being adhered to, the occurrences of all of the events in the manufacturing plant are monitored continuously in real time. In case of any deviation of the monitored events from the predefined state of events, future occurrences of all of the monitored events are predicted for one or more predefined instances of time, based on the current state of the monitored events and various parameters associated with the monitored events. Thereafter, the reference schedule of the set of events is optimized on the basis of the predicted state of the monitored events. The optimization of the reference schedule is done by optimizing an objective function associated with the reference schedule. The optimization of the objective function considers various constraints associated with the manufacturing plant. The method and system based on quick re-optimization of the reference schedule facilitates regeneration of the schedule in real time.

The reference schedule can be the first or an initial schedule for the processes in the manufacturing plant over the scheduling horizon. The method and system also generates the first schedule of the set of events. The generation of the first schedule is based on an initial state of the events. The initial state is a state of the events monitored at a time before the current schedule horizon.

The method and system described above have a number of advantages. The method generates and regenerates a schedule of a set of events in a manufacturing plant. Firstly, the quality of the schedule that is actually executed in the manufacturing plant is superior, in terms of having few constraint violations, to the quality of the schedule according to the current state of the art based on dispatch heuristics. Such real-time optimization considers events in other areas of the manufacturing plant and predicts the consequences of executing the reference schedule. This helps in coordinating various processes in the manufacturing plant in an efficient manner. Secondly, the schedule generated by the method is always feasible, since the system automatically responds to the changes in the manufacturing environment that can render an optimized schedule generated off line infeasible. The system is capable of responding to occurrence of events in real time by regenerating the schedule of the set of events without the need of manual intervention.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 illustrates an environment in which various embodiments of the invention may be practiced;

FIG. 2 is a flow diagram illustrating a method for regenerating a schedule of a set of events associated with at least one process of one or more processes in a manufacturing plant, in accordance with an embodiment of the invention;

FIG. 3 is a flow diagram illustrating a method for generating a first schedule of a set of events associated with at least one process of one or more processes in a manufacturing plant, in accordance with an embodiment of the invention;

FIG. 4 is a block diagram of a system for regenerating a schedule in real time, in accordance with an embodiment of the invention; and

FIG. 5 is a block diagram illustrating a system being used in an automobile manufacturing plant.

### DESCRIPTION OF VARIOUS EMBODIMENTS

For purposes of clarity, the following terms used herein are defined below:

Throughput: Throughput is defined as a rate of production of a defined system or process over a stated period of time. The rate may be expressed in terms of units of products, batches produced, dollar turnover, or other meaningful measurements.

Utilization: Utilization is defined as the ratio of the time a resource is productively used to the maximum time that it can be used.

Productivity: Productivity is used to measure the efficiency of production. Productivity is expressed as a ratio of output over input.

Job: A job is a unit of production. From a scheduling perspective, a job is an object, an activity, or a process that needs to be scheduled.

Target: The target of a manufacturing plant is an objective to be achieved. The objective of the manufacturing plant includes certain productivity, a certain throughput, and the like.

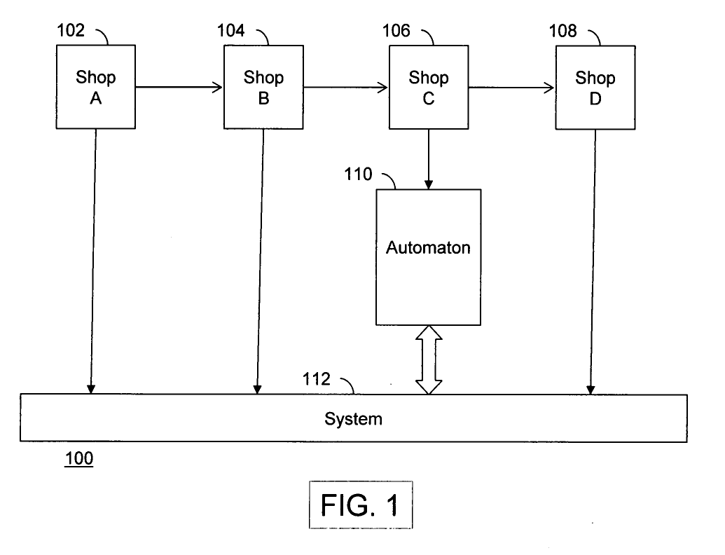

FIG. 1 illustrates an environment in which various embodiments of the invention may be practiced. Typically, a manufacturing plant 100 is a set up to manufacture a product. In manufacturing plant 100, one or more processes are carried out to manufacture the product. The processes may be carried out at shops A 102, B 104, C 106 and D 108 in a predefined order on a job. For example, welding may be carried out at shop A 102 on the job followed by paint carried out at shop B 104, and so on, in manufacturing plant 100, for example, an automobile manufacturing plant. The one or more processes and the corresponding shops, both are hereinafter represented by the same numerals 102, 104, 106 and 108. Further, one or more events are associated with the processes. For example, the welding process has some associated events such as ‘weld in’ and ‘weld out’. Similarly, the paint process has some associated events such as ‘paint in’ and ‘paint out,’ and the storage and retrieval process has associated events such as ‘move the painted body A in the storage area’ and ‘move the painted body B out of the storage area’.

At least one process has an associated automaton 110 to carry out a set of events. In various embodiments of the invention, the stage in the manufacturing process where automaton 110 is applied is referred to as an application point. An application point is a stage in the manufacturing process at which a scheduler is used to re-order the flow of jobs to match downstream manufacturing constraints in a better manner. One or more scheduling processes may be included in an application point. For example, for an ASRS application point, the optimized schedule may include job storage and job retrieval processes. In addition, the events can be grouped into upstream events, downstream events and mainstream events with respect to the position of the automaton associated with the at least one process/application point in the manufacturing plant. Upstream events are the events that are associated with a process preceding the automaton. Downstream events are the events that are associated with a process succeeding the automaton. Mainstream events are the events that are associated with the application point. It should be noted that the mainstream events are the set of events for which the schedule is regenerated.

In the block diagram shown in FIG. 1, automaton 110 is used to implement a schedule of a set of events associated with process 106. An example of process 106 is storage and retrieval. Further, the associated set of events such as ‘move the painted body A in the storage area’ and ‘move the painted body B out of the storage area’ are implemented by automaton 110. It may be apparent to any person skilled in the art that automaton 110 adheres to the schedule to carry out the set of events. In other words, automaton 110 performs actions/events by generating control and selection messages based on the schedule. In an embodiment of the invention, the application point can be the entry point to feeder lines, assembly lines, buffer areas, and the like. An example of automaton 110 is an Automated Storage and Retrieval Systems (ASRS) used to automate storage and movement of painted automobile units between a paint line and an assembly line. Further, in various embodiments of the invention, the storage and retrieval area is also referred to as buffer. Examples of storage buffers include, but are not limited to, ASRS with multiple aisles and cranes, First in First out (FIFO) buffers with multiple lanes, and FIFO buffers with multiple lanes that allow recirculation among the jobs stored in a lane.

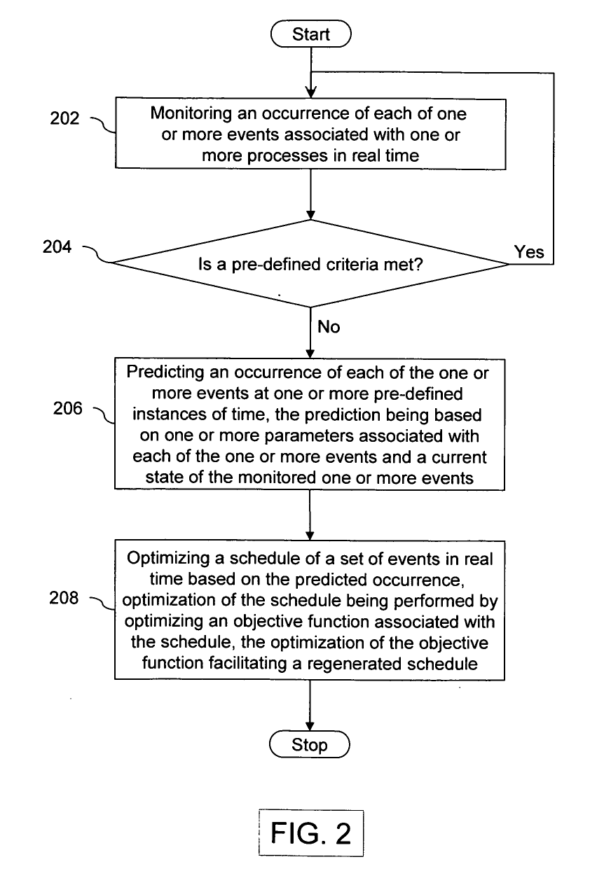

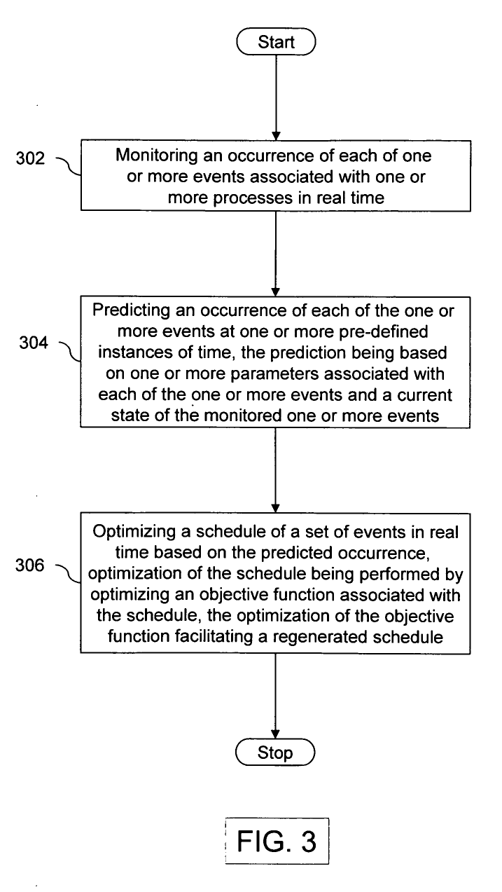

In various embodiments of the invention, system 112 is connected to and/or integrated with automaton 110 and may be used to control the same. System 112 regenerates the schedule of the set of events associated with process 106 based on the occurrence of various events in real time. Examples of the events occurring in real time include, but are not limited to, breakdown of a tool in a shop in the manufacturing plant and failure of meeting deadline by a shop. Further, the regeneration of the schedule of the set of events associated with process 106 is described in detail in conjunction with FIG. 2. In another embodiment of the invention, system 112 generates a first schedule of the set of events described in detail in conjunction with FIG. 3.

FIG. 2 is a flow diagram illustrating a method for regenerating a schedule of a set of events associated with at least one process of one or more processes in a manufacturing plant, in accordance with an embodiment of the invention. In various embodiments of the invention, the at least one process has an associated automaton. For example, if the process is storage and retrieval, then the associated automaton is an Automatic Storage and Retrieval System (ASRS). Further, various examples of the set of events associated with ASRS may include moving bodies ‘in’ and ‘out’ of the storage and retrieval area. Furthermore, various cranes may be used to move the bodies in and out of various racks in the storage and retrieval area.

In various embodiments of the invention, the schedule is regenerated from an initial schedule, hereinafter referred to as a reference schedule. Examples of reference schedules include, but are not limited to, a previous schedule for the application point, a schedule for a different application point, and a schedule generated by an external scheduling system.

The reference schedule can be generated by various scheduling and sequencing algorithms. Examples of the scheduling and sequencing algorithms that can be used for scheduling/sequencing of real-time plant events are described in a United States patent application titled, ‘Method and System for Solving an Optimization Problem’, application Ser. No. 10/975,751, assignee NETAPS INC., filed on Oct. 28, 2004; and a United States patent application titled, ‘Method and System for Sequencing and Scheduling’, application Ser. No. 10/975,877, assignee NETAPS INC., filed on Oct. 28, 2004; are hereby incorporated by reference. It will be apparent to any person skilled in the art that various other scheduling and sequencing algorithms can also be used to regenerate the schedule, as long as the re-optimization can meet response time requirements.

With an assumed configuration of a 2 aisle ASRS with 2 cranes where each crane has 1 associated storage rack (i.e., Aisle1 is associated with Crane1 and Rack1, and Aisle2 is associated with Crane2 and Rack2), elements of an exemplary reference schedule associated with the ASRS for transferring the painted bodies from storage and retrieval area to an assembly shop is:
a) Crane1 stores a painted body that arrives from the paint shop, with ID A in Rack1 at 3:50 a.m.,
b) Crane2 stores a painted body that arrives from the paint shop, with ID B in Rack2 at 3:52 a.m.,
c) Crane1 stores a painted body that arrives from the paint shop, with ID C in Rack1 at 3:54 a.m.,
d) Crane2 stores a painted body that arrives from the paint shop, with ID D in Rack2 at 3:56 a.m.,
e) Crane1 retrieves painted body with ID A at 7:30 a.m. out of the Rack1, so that it may be transferred to the final assembly,
f) Crane2 retrieves painted body with ID B at 7:32 a.m. out of the Rack2, so that it may be transferred to the final assembly,
g) Crane1 retrieves painted body with ID C at 7:34 a.m. out of the Rack1, so that it may be transferred to the final assembly,
h) Crane2 retrieves painted body with ID D at 7:36 a.m. out of the Rack2, so that it may be transferred to the final assembly, and so on.

In various embodiments of the invention, one or more events associated with the processes are characterized. As explained earlier, the events are associated with the processes of the manufacturing plant. The characterization of the events includes defining types of the events and one or more parameters associated with each of the events. Examples of the associated parameters may include, but are not limited to, the process time of the process associated with the event, the number of jobs at the stage of the event, the state of tools used in the process associated with the event, the size of storage buffers, the coordinates of a storage bin, the distance between two storage bins, the number of aisles in an AMHS (automaton), the number of cranes, the nearest bin from a particular bin, the speed of the crane while moving from a first bin to a second bin, and the like. The characterization of the events also includes assigning an importance level or weight to each of the events. Critical events having high impact on the performance of the manufacturing plant are assigned a higher weight than the events that minimally affect the performance of the manufacturing plant. In various embodiments of the invention, the characterization of the events is performed by an applications engineer implementing the scheduling system, or an administrator or a staff member of the manufacturing plant, hereinafter referred to as a user.

At step 202, occurrences of all of the events in the manufacturing plant are monitored continuously in real time. The step of monitoring includes capturing the events in real time. In various embodiments of the invention, monitoring in real time is performed with the help of sensing mechanisms/sensors.

Following the example above, the current state of the events monitored in real time at 4:00 a.m. is:
a) 4 unpainted bodies with IDs G, H, I and J entering the paint shop from the weld shop;
b) 1 body with ID F being processed in the paint shop;
c) 2 painted bodies with IDs A and C stored in the Rack1 of the storage and retrieval area; and
d) 2 painted bodies with IDs B and D stored in the Rack2 of the storage and retrieval area.

The parameters associated with the paint shop include:
a) 3 hours of process time; and
b) Capacity of 30 jobs per hour

Please note that 3 hours of process time for the paint shop has been mentioned only for illustrative purposes. Process times of typical automobile paint shops are significantly more than 3 hours

The example given above considers events associated only with the paint shop, the storage and retrieval area, and the assembly shop. It should be apparent to a person skilled in the art that the same steps are equally applicable to events associated with other shops, for example, welding and stamping. In various embodiments of the invention, monitoring in real time is performed with the help of sensing mechanisms.

At step 204, it is determined if the predefined criteria are met. In an embodiment of the invention, the predefined criteria include a condition to check if the reference schedule is adhered to in the manufacturing plant. According to the example given above, based on the reference schedule, the painted bodies with IDs A, B, C, and D should be stored in the storage and retrieval area after 3:56 a.m. These painted bodies are planned to be retrieved beginning at 7:30 a.m. to transfer them to the final assembly. If the occurrences of the monitored events are as per the reference schedule, then the monitoring of the events are continued as mentioned in step 202. However, if the monitored events are not adhering to the reference schedule, such as the painted bodies with IDs A, B, C, and D are successfully stored in the ASRS racks by the cranes according to the reference schedule, but an unplanned event occurs at 4:00 a.m. in which Crane1 has a major fault and requires to be taken out of service for repairs, then step 206 is performed. Furthermore, the occurrence of Crane1 out of service results in painted bodies with IDs A and C not being available to be retrieved at 7:30 a.m. and 7:34 a.m., respectively, and therefore, these jobs will not meet their deadlines for arrival in the final assembly which are considered hard constraint violations. Hard constraints are explained in detail in the later paragraphs. It may be apparent to any person skilled in the art that there can be various other events that can occur in real time in the manufacturing plant.

At step 206, an occurrence of the monitored events is predicted at one or more predefined instances of time. Various examples of the predefined instances of time are in the range of microseconds to days. It should be noted that the range of the predefined time instances has been mentioned as an example and does not limit the scope of the invention in any way. The prediction is based on the parameters and the current state of the monitored events. For example, the current state of the monitored events suggests that the storage and retrieval area has only 2 painted bodies with IDs B and D that will meet their deadlines for arrival in the final assembly since the painted bodies with IDs A and C cannot be retrieved because Crane1 is out of service.

Based on the current state, as per the example above, an exemplary predicted state can be:
a) The availability of 5 painted bodies F, G, H, I and J at 7:00 a.m. leaving the paint shop that may be subsequently transferred to the final assembly. This is predicted on the basis of the parameter, ‘process time’ of 3 hours and ‘capacity’ of 30 jobs per hour, associated with the paint shop.
   a. ‘paint out’ at 7:00 a.m. because painted body with ID F is leaving the paint shop
   b. ‘paint out’ at 7:02 a.m. because painted body with ID G is leaving the paint shop
   c. ‘paint out’ at 7:04 a.m. because painted body with ID H is leaving the paint shop
   d. ‘paint out’ at 7:06 a.m. because painted body with ID I is leaving the paint shop
   e. ‘paint out’ at 7:08 a.m. because painted body with ID J is leaving the paint shop
b) ‘store in’ events occur at the following times because Crane2 stores each of the 5 painted bodies with IDs F, G, H, I and J in Rack2:
   a. ‘store in’ at 7:10 a.m. because painted body with ID F is stored
   b. ‘store in’ at 7:12 a.m. because painted body with ID G is stored
   c. ‘store in’ at 7:14 a.m. because painted body with ID H is stored
   d. ‘store in’ at 7:16 a.m. because painted body with ID I is stored
   e. ‘store in’ at 7:18 a.m. because painted body with ID J is stored
c) availability for retrieval of 7 (5 newly stored (F, G, H, I and J)+2 previously stored (B and D)) painted bodies stored in Rack2 of the storage and retrieval area at 7:18 a.m.

It can be noted that the prediction also considers the unavailability of the painted bodies A and C stored in Rack1 of the storage and retrieval area, based on the monitored events.

According to the reference schedule, painted bodies with IDs A, B, C, and D are scheduled to be retrieved out of the storage and retrieval area at 7:30 a.m., 7:32 a.m., 7:34 a.m., and 7:36 a.m., respectively. However, it can be clearly observed that according to the predicted state, 7 painted bodies will be available for retrieval from the storage and retrieval area after 7:18 a.m. Therefore, at step 208 the reference schedule is optimized to regenerate the schedule of the set of events. The schedule is optimized in response to the violations of the hard constraint, i.e., the painted bodies with IDs A and C cannot be retrieved due to Crain1 being out of service. The optimization of the reference schedule is explained in detail in following paragraphs. In an embodiment of the invention, following the example above, the regenerated schedule may include:
a) Crane2 retrieves painted body with ID D at 7:30 a.m. out of the Rack2, so that it may be transferred to final assembly,
b) Crane2 retrieves painted body with ID I at 7:32 a.m. out of the Rack2, so that it may be transferred to final assembly,
c) Crane2 retrieves painted body with ID F at 7:34 a.m. out of the Rack2, so that it may be transferred to final assembly,
d) Crane2 retrieves painted body with ID B at 7:36 a.m. out of the Rack2, so that it may be transferred to final assembly, and so on.

It can be noted that the event of retrieval of painted bodies with IDs A and C are not in the regenerated schedule, based on the predicted state of the monitored events. The painted bodies with IDs A and C cannot be retrieved as per the earlier schedule due to Crain1 being out of service and instead are replaced by painted bodies with IDs I and F, respectively, in the re-optimized schedule. However, the painted bodies with IDs A and C can be rescheduled to be retrieved by Crane1 after Crane1 resumes service.

It can be clearly observed that monitoring the events associated with paint and the predicted events help to regenerate the schedule for a longer duration of time, i.e., the schedule of events to be performed at 7:30 a.m. is regenerated at 4:00 a.m. according to the predicted events. In other words, the predicted events allow the schedule to be regenerated for longer duration covering larger number of events.

It may be apparent to a person skilled in the art that 3:50 a.m., 3:52 a.m., 3:54 a.m., 3:56 a.m., 4:00 a.m., 7:00 a.m., 7:02 a.m., 7:06 a.m., 7:08 a.m., 7:10 a.m., 7:12 a.m., 7:16 a.m., 7:18 a.m., 7:30 a.m., 7:32 a.m., 7:34 a.m., and 7:36 a.m. are the examples of the predefined instances of time and the actual instances of time of the events may vary.

In various embodiments of the invention, the current state and the predicted state of the monitored one or more events are stored. In various embodiments of the invention, an image of the current state and the predicted state are stored. The image is derived from the states of the monitored events. Thereafter, the generation/regeneration of the schedule is based on the current image and the stored predicted image of the processes in the manufacturing plant.

As mentioned earlier, the reference schedule is optimized to regenerate the schedule on the basis of the predicted state of the monitored events at step 206. The schedule is regenerated by optimizing the objective function associated with the schedule. A sample objective function is as follows:

$${\sum }_{i} {{w}_{i} ( {\sum }_{j} {v}_{ij}^{{s}_{i}} )}^{\frac{1}{{s}_{i}}}$$

where, wᵢ=weight assigned to constraint i
vij=a violation metric, or a measure of violation j of constraint i
sᵢ=a severity factor or non-negative exponent assigned to constraint i

The objective function is a surrogate of an actual dollar cost function, and it is a weighted sum of the impacts of the violations of the defined constraints. Conceptually, generating a schedule that minimizes such an objective function will also generate a least cost schedule. Various examples of constraints may include not scheduling a certain feature ‘back to back’; ensuring no more than ‘y’ occurrence of a feature in any window of ‘x’ sequence positions; making sure that a job is produced by its due time; keeping parts inventories between a minimum and maximum values; minimizing the movements of the automaton, throughput time, and the like. It may be apparent to any person skilled in the art that other objective functions can be defined within the scope of this invention.

In an embodiment of the invention, the constraints are categorized as hard constraints and soft constraints. Hard constraints are such constraints that violation of any of them makes a schedule of the set of events infeasible. For example, scheduling a body for transfer to the final assembly before it arrives in the ASRS storage area is a physical impossibility, and will render a schedule with such a condition infeasible. Soft constraints are such constraints that their violations in a schedule are undesirable since they incur added costs, but they do not render the schedule infeasible. For example, there may be a soft constraint that specifies no ‘back-to-back’ occurrences of a given order feature be planned in the schedule. However, the schedule is still feasible in practice with the added manpower if a ‘back-to-back’ violation of the soft constraint occurs.

It may be apparent to any person skilled in the art that these constraints are decided on the basis of the requirements associated with the manufacturing plant. Various examples of the requirements include meeting the delivery schedule of the finished products, minimizing the operational costs, minimizing the average wait time in the buffer, and the like.

Various algorithms are used to regenerate the schedule for the prediction made at step 206. Examples of the scheduling and sequencing algorithms that can be used for scheduling/sequencing of real-time plant events are described in a United States patent application titled, ‘Method and System for Solving an Optimization Problem’, application Ser. No. 10/975,751, assignee NETAPS INC., filed on Oct. 28, 2004; and a United States patent application titled, ‘Method and System for Sequencing and Scheduling’, application Ser. No. 10/975,877, assignee NETAPS INC., filed on Oct. 28, 2004; are hereby incorporated by reference. It may be apparent to any person skilled in the art that various other scheduling and sequencing algorithms can also be used to regenerate the schedule.

In an embodiment of the invention, the regenerated schedule maintains bias, or is close to the reference schedule, i.e., one of the requirements of rescheduling is to have minimal deviations from the reference schedule. Further, it may be apparent to any person skilled in the art that one of the constraints considered in the objective function is the bias to the reference schedule. The optimization balances the need to accommodate the changes that triggered the reschedule, while minimizing the possibility of deviation from the reference schedule.

In another embodiment of the invention, the method explained in FIG. 2 is used for generating a first schedule of the set of events. The first schedule is generated based on at least one of the predicted occurrence and the initial state of the monitored one or more events and the one or more constraints. In this case, the initial state of the monitored one or more events is a state at a time before the current schedule horizon. The generation of the first schedule is explained in detail in FIG. 3.

In an embodiment of the invention, a buffer used in the storage and retrieval area to store the jobs may be a lane (channel) bank, a re-circulating lane bank, and the like.

In another embodiment of the invention, using an Automated Storage and Retrieval System (ASRS) as an automaton, the schedule is generated/regenerated for the set of events associated with selecting a bin in the ASRS. The bin may be selected to move a job in or out of the bin.

Similarly, in another embodiment of the invention, the schedule is generated/regenerated for the set of events associated with selecting a lane in the lane bank to move a job in or out of the lane.

In yet another embodiment of the invention, using an Automatic Material Handling System (AMHS) as an automaton, the schedule is generated/regenerated for the set of events associated with the movements of a crane of the AMHS.

In another embodiment of the invention, in a semiconductor manufacturing plant, the schedule corresponds to the movements of a vacuum robot in a cluster tool, where the vacuum robot is used as an automaton.

Similarly, in an embodiment of the invention, in a semiconductor manufacturing plant, the schedule corresponds to the movements of an atmospheric robot in a cluster tool, where the atmospheric robot is used as an automaton.

FIG. 3 is a flow diagram illustrating a method for generating a first schedule of a set of events associated with at least one process of one or more processes in a manufacturing plant, in accordance with an embodiment of the invention. As explained earlier, the processes in the manufacturing plant have associated one or more events and various parameters are associated with each of the events.

In various embodiments of the invention, the at least one process has an associated automaton to perform the set of events. To perform actions associated with the set of events, the automaton adheres to a schedule. The schedule of the set of events is generated in real time.

At step 302, the occurrence of the events is monitored continuously in real time. Some examples of the monitored events occurring in real time include ‘3 unpainted bodies with IDs M, N and O being processed by the weld shop’, ‘5 unpainted bodies with IDs P, Q, R, S and T entering the paint shop’, and the like. In various embodiments of the invention, monitoring in real time is performed with the help of sensing mechanisms/sensors.

At step 304, the occurrence of each of the events at one or more predefined instances of time is predicted. The prediction is based on an initial state and the associated parameters of the monitored events. The initial state of the monitored events is the state of the events at a time before the current schedule horizon.

For example, if the initial state of the monitored events in real time at 4:00 a.m. is:
a) 5 unpainted automobile bodies with IDs P, Q, R, S and T entering the paint shop
b) No automobile bodies inside the paint shop

And the associated parameters are:
a) Process time of 3 hours, and
b) Capacity of 30 jobs per hour

Please note that 3 hours of process time for the paint shop has been mentioned only for illustrative purposes. The process times of typical automobile paint shops are significantly more than 3 hours.

Based on the initial state, as per the example above, an exemplary predicted state can be:
a) The availability of 5 painted bodies P, Q, R, S and T at 7:00 a.m. leaving the paint shop that may be subsequently transferred to the final assembly. This is predicted on the basis of the parameters, process time of 3 hours and capacity of 30 jobs per hour, associated with the paint shop.
   a. ‘paint out’ at 7:00 a.m. because painted body with ID P is leaving the paint shop
   b. ‘paint out’ at 7:02 a.m. because painted body with ID Q is leaving the paint shop
   c. ‘paint out’ at 7:04 a.m. because painted body with ID R is leaving the paint shop
   d. ‘paint out’ at 7:06 a.m. because painted body with ID S is leaving the paint shop
   e. ‘paint out’ at 7:08 a.m. because painted body with ID T is leaving the paint shop

At step 306, the first schedule of the set of events is optimized in real time, based on the predicted occurrence of the monitored events. The optimization of the first schedule is done by optimizing an objective function associated with the schedule. The objective function is optimized on the basis of one or more constraints associated with the manufacturing plant. These constraints are empirically related to the objective function. Details of the constraints have been explained in detail in FIG. 2.

An exemplary first schedule can be:
a) Crane1 stores a painted body that arrives from the paint shop, with ID P in Rack1 at 7:10 a.m.,
b) Crane2 stores a painted body that arrives from the paint shop, with ID Q in Rack2 at 7:12 a.m.,
c) Crane1 stores a painted body that arrives from the paint shop, with ID R in Rack1 at 7:14 a.m.,
d) Crane2 stores a painted body that arrives from the paint shop, with ID S in Rack2 at 7:16 a.m.,
e) Crane1 stores a painted body that arrives from the paint shop, with ID T in Rack1 at 7:18 a.m.,
f) Crane1 retrieves painted body with ID P at 7:30 a.m. out of the Rack1, so that it may be transferred to the final assembly,
g) Crane2 retrieves painted body with ID Q at 7:32 a.m. out of the Rack2, so that it may be transferred to the final assembly,
h) Crane1 retrieves painted body with ID R at 7:34 a.m. out of the Rack1, so that it may be transferred to the final assembly,
i) Crane2 retrieves painted body with ID S at 7:36 a.m. out of the Rack2, so that it may be transferred to the final assembly,
j) Crane1 retrieves painted body with ID T at 7:38 a.m. out of the Rack2, so that it may be transferred to the final assembly, and so on.

Various algorithms are used to generate the first schedule for the prediction made at step 304. Examples of the scheduling and sequencing algorithms that can be used for scheduling/sequencing of real-time plant events are described in a United States patent application titled, ‘Method and System for Solving an Optimization Problem’, application Ser. No. 10/975,751, assignee NETAPS INC., filed on Oct. 28, 2004; and a United States patent application titled, ‘Method and System for Sequencing and Scheduling’, application Ser. No. 10/975,877, assignee NETAPS INC., filed on Oct. 28, 2004; are hereby incorporated by reference. It may be apparent to any person skilled in the art that various other scheduling and sequencing algorithms can also be used to generate the first schedule.

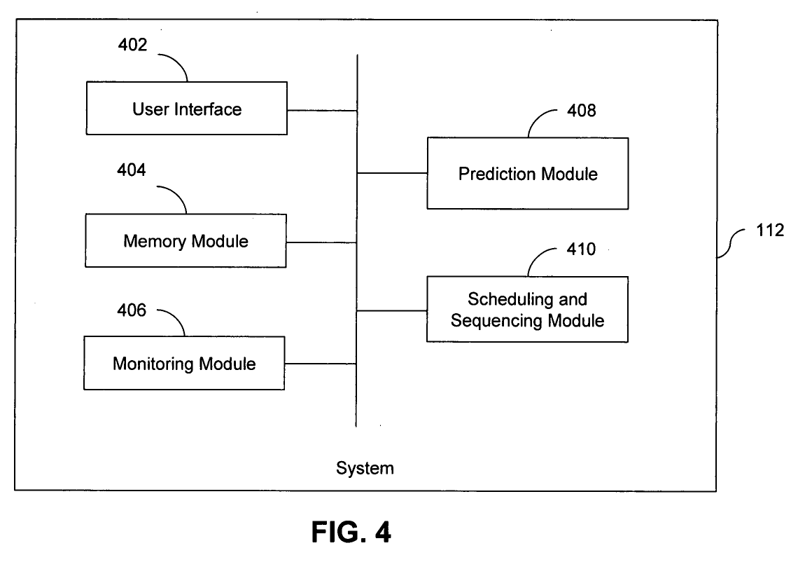

FIG. 4 is a block diagram of system 112 for generating/regenerating a schedule in real time, in accordance with an embodiment of the invention. System 112 includes a user interface 402, a memory module 404, a monitoring module 406, a prediction module 408, and a scheduling and sequencing module 410.

System 112 generates/regenerates a schedule of a set of events. In an embodiment of the invention, the schedule of the set of events can be imported from other systems, hereinafter referred to as a reference schedule. In another embodiment of the invention, system 112 can generate the reference schedule. In various embodiments of the invention, the reference schedule can be a first schedule or an earlier regenerated schedule.

The reference schedule is adhered to by the system 112 for the implementation of the set of events. Further, the reference schedule for the set of events is explained in detail in conjunction with FIG. 2. The set of events is associated with at least one process of one or more processes in a manufacturing plant. As explained earlier, the processes have one or more events associated with them.

User interface 402 enables a user to characterize each of the events. Characterizing the events includes defining the types of events and one or more parameters associated with each of the events. Further, user interface 402 also enables the user to assign an importance level to each of the events. As explained earlier, critical events having a high impact on the performance of the manufacturing plant are assigned a higher importance level than the events that minimally affect the performance of the manufacturing plant. For example, upstream and downstream job location events such as weld in, weld out, paint in, paint out and FA in and FA out have the lowest importance level since the prediction of events have the least impact on the schedule, as these events are for future mainstream jobs that may differ quite a bit over time from the prediction. Mainstream job location events ASRS in and ASRS out have the next higher level of importance since the prediction of events have more impact on the schedule, as these events are for the current mainstream jobs. If these events differ from the prediction, need for rescheduling occurs. Other events such as change in the equipment status and constraint changes have the highest importance levels since they have the highest impact on the prediction when a new schedule needs to be generated.

User interface 402 enables the user to define one or more constraints arising due to the various requirements of the manufacturing plant. In an embodiment of the invention, characterizations of the events, definitions of associated parameters, assigned levels of importance to each of the events, and definitions of the constraints are imported from another system. Further, the characterization of the events is explained in detail in conjunction with FIG. 2.

Memory module 404 stores the definitions of the parameters associated with the events and the constraints associated with the manufacturing plant. In an embodiment of the invention, memory module 404 stores the parameters and the constraints in the form of a data dictionary. Further, the data dictionary stores parameters defined to control field structures, validations, labels and logic in text-based scripts. In an embodiment of the invention, the logic in the text-based scripts is written in JAVA. It should be apparent to a person skilled in the art that the text-based scripts can be written in various computer languages other than JAVA.

In various embodiments of the invention, memory module 404 also stores events and processes-related information in the form of configuration tables. An example of event-related information includes, but is not limited to, the format of the events, which is required to parse the events being monitored. Further, an example of process-related information includes, but is not limited to, the set of actions performed by the automaton to execute the process under normal operation and the set of actions to be taken when a tool breaks down. Further, in various embodiments of the invention, memory module 404 stores information related to configuration settings corresponding to different events and processes in text configuration files. Text configuration files may be derived from external sources, and are used to populate configuration tables.

In an embodiment of the invention, the data dictionary and the configuration tables can be implemented in various database management systems. It should be apparent to a person skilled in the art that various other ways can be used to implement the data dictionary and the configuration tables.

Monitoring module 406 continuously monitors the events associated with various processes in real time. For example, 4 bodies A, B, C and D going into the paint shop, 5 painted bodies P, Q, R, S and T stored in the storage and retrieval area are a state of the monitored events in real time. In various embodiments of the invention, the events being monitored are associated with the various processes of the manufacturing plant. Further, monitoring of the events has been explained in detail in conjunction with FIG. 2.

Prediction module 408 predicts an occurrence of each of the events at one or more predefined instances of time. Further, prediction module 408 predicts the occurrences on the basis of the parameters associated with the events, a current state of the monitored events and predefined criteria. The predefined criteria are explained in detail in conjunction with FIG. 2.

In an embodiment of the invention, a logic/computer code enabling predictions, based on the parameters associated with the monitored events, is stored as text-based scripts in memory module 404.

The predefined criteria include checking whether the reference schedule is being adhered to. The checking of adherence to the reference schedule is based on the current state and the parameters associated with the monitored events. If the predefined criteria are not being met, prediction module 408 predicts the occurrence of the monitored events at one or more predefined instances of time, based on the current state. The prediction of the occurrences of the events is explained in detail in FIG. 2. Various examples of the predefined instances of time are in the range of microseconds to days. It should be noted that the range of the predefined time instances is mentioned as an example and does not limit the scope of the invention in any way.

Based on the predicted occurrence of the monitored events, scheduling and sequencing module 410 optimizes the reference schedule of the set of events. The optimization of the reference schedule is performed by optimizing the objective function associated with the schedule. The objective function is optimized on the basis of one or more constraints associated with the manufacturing plant. In various embodiments of the invention, scheduling and sequencing module 410 optimizes the objective function to facilitate generation/regeneration of an optimized schedule.

Various algorithms are used to generate/regenerate the schedule for the prediction made by prediction module 408. Examples of the scheduling and sequencing algorithms that can be used for scheduling/sequencing of real-time plant events are described in a United States patent application titled, ‘Method and System for Solving an Optimization Problem’, application Ser. No. 10/975,751, assignee NETAPS INC., filed on Oct. 28, 2004; and a United States patent application titled, ‘Method and System for Sequencing and Scheduling’, application Ser. No. 10/975,877, assignee NETAPS INC., filed on Oct. 28, 2004; are hereby incorporated by reference. It may be apparent to any person skilled in the art that various other scheduling and sequencing algorithms can also be used to generate/regenerate the schedule.

In an embodiment of the invention, scheduling and sequencing module 410 generates a first schedule of the set of events based on the constraints, an initial state and the predicted state of the monitored events. The initial state is a state of the monitored events at a time before the current schedule horizon.

In various embodiments of the invention, memory module 404 also stores various states of the monitored events. The various states of the monitored events include the initial state, the current state, and the predicted state of the monitored events.

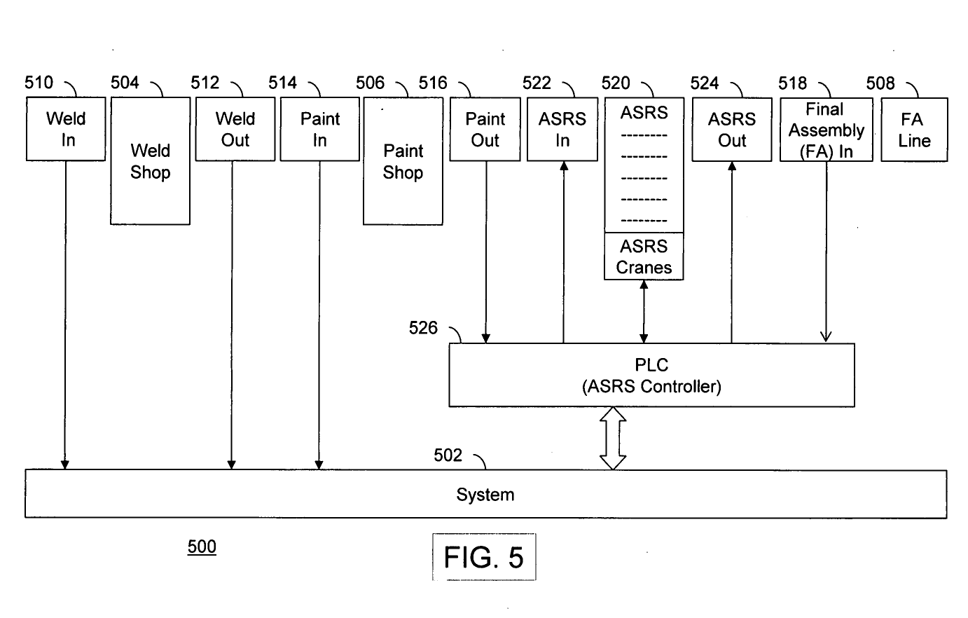

For the sake of clarity, the present invention has also been described with help of an example in FIG. 5.

FIG. 5 is a block diagram illustrating a system 502 being used in an automobile manufacturing plant 500. A typical automobile manufacturing plant, such as automobile manufacturing plant 500, generally includes at least three processes, for example, a weld shop 504, a paint shop 506, and a final assembly line 508. Weld shop 504 can also be referred to as a body shop and final assembly line 508 can be termed as a trim line. Each of the three processes includes an input event and output event. For example, weld shop 504 includes a weld-in 510 and weld-out 512 events. Paint shop 506 includes a paint-in 514 event for input and paint-out 516 event for output. Similarly, final assembly line 508 includes a Final Assembly (FA)-in 518 as an input event and an output event (not shown in the figure).

In the automobile manufacturing plant, an automaton, for example, an Automated Storage and Retrieval System (ASRS) 520 is used to store the painted automobile bodies exiting the paint shop. ASRS 520 systems are available in different configurations and can contain bins of the order of 100 to 1000. Each bin in ASRS 520 can store a painted automobile body. ASRS 520 has mailbox type architecture which means that each bin can be randomly accessed. A crane stores a painted automobile body in a bin. The crane can also retrieve a painted automobile body from a bin and send the painted automobile body to the final assembly line. The operations of ASRS 520 and cranes are controlled by a programmable logic controller (PLC) 526. The functions of PLC 526 include monitoring (tracking or registering) painted automobile bodies leaving paint shop 506 (the frequency of the painted automobile body leaving paint shop 506 should match the production rate of paint shop 506), directing a crane to pick and store the painted automobile body in an open bin, receiving a request for sending the next painted automobile body to final assembly line 508 when final assembly line 508 is ready to receive the next painted automobile body, selecting the next painted automobile body to send to final assembly line 508 (the frequency of sending the painted automobile bodies should match the production rate of final assembly line 508, for example, the production rate may be 60 automobile bodies per hour), directing the crane to retrieve the next painted automobile body from a bin and send to final assembly line 508. According to known prior arts, PLC 526 performs the key function of selecting the next painted automobile body. For example, in ASRS 520 with 100 bins, PLC 526 needs to select a painted automobile body to be sent to final assembly line 508 from the 100 units stored in 100 bins in ASRS 520.

The logic for the selection followed by PLC 526 considers the constraints applicable to final assembly line 508. The constraints are derived from physical, staffing, and/or material-related constraints. The following constraint is considered for further illustration of the constraints:

Constraint 1: No Back-to-Back Jobs with Satellite-Radio

A PLC selection logic with the constraints above results in a problem if the ratio of satellite-radio to non-satellite-radio automobile bodies in ASRS 520 is not exactly 50:50. For example, if, according to the reference schedule, ASRS 520 contains 55 satellite-radio automobile bodies, then PLC 526 can satisfy the constraints above only for the first 90 automobile bodies. Thereafter, PLC 526 may be forced to select 10 satellite-radio automobile bodies in a row, which creates a constraint violation. This type of constraint violation is an example of the violation of the soft constraints, as explained earlier.

For this type of manufacturing problem, the number of different constraints can range from 20 to 200, which increases the complexity of the PLC selection logic. Generally, the PLC selection logic is able to handle only two to five constraints.

The present invention replaces the PLC selection logic with an optimization algorithm. When PLC 526 receives a selection request from final assembly line 508, the request is passed to system 502, as proposed by the present invention. System 502 provides various improvements over the PLC selection logic. The optimization algorithm used by system 502 is more efficient than the ones existing in the prior art. Examples of the optimization algorithm are described in a United States patent application titled, ‘Method and System for Solving an Optimization Problem’, application Ser. No. 10/975,751, assignee NETAPS INC., filed on Oct. 28, 2004; and a United States patent application titled, ‘Method and System for Sequencing and Scheduling’, application Ser. No. 10/975,877, assignee NETAPS INC., filed on Oct. 28, 2004; are hereby incorporated by reference. It may be apparent to any person skilled in the art that various other scheduling and sequencing algorithms can also be used to generate the first schedule. The optimization algorithm used by system 502 complements an ASRS system image maintained by PLC 526 with the captured and tracked upstream and downstream plant events. Moreover, system 502 can monitor upstream plant events such as the unpainted automobile bodies leaving weld shop 504 and the unpainted automobile bodies entering paint shop 506.

The monitoring of upstream plant events provides the time of occurrences of the upstream plant events. System 502 can predict an arrival time of the painted automobile bodies at ASRS 520, based on the time of occurrences of the upstream plant events. If the upstream plant events relate to 200 automobile bodies, then system 502 has the information relating to 300 automobile bodies, including 200 upstream automobile bodies and 100 automobile bodies already stored in the ASRS. The upstream automobile bodies are predicted to arrive at ASRS 520 at a future time.

System 502 generates schedules for a larger pool of automobile bodies. The larger pool of automobile bodies will result in a more optimized schedule and the number of violations of the constraints will decrease. The optimization should ensure that the upstream plant events cannot be scheduled before their predicted arrival time. System 502 triggers the optimization algorithm for generating the schedule. The optimization algorithm runs internally based on an examination of internal image of the state of the processes combining both the upstream automobile bodies and the automobile bodies in ASRS 520. System 502 stores the resulting schedule for responding to the selection requests from PLC 526. PLC 526 passes the selection requests to system 502 when final assembly line 508 requests PLC 526 for a next automobile body. System 502 checks the stored schedule and informs PLC 526 about the best next painted automobile body to be selected, thereby providing a real time selection response.

The optimization algorithm mitigates the satellite-radio problem in final assembly line 508 described earlier. Instead of deferring the constraint violations to a large ‘un-buildable’ group of 10 consecutive satellite-radio automobile bodies, system 502 will smooth the violations throughout the sequence to reduce the impact of the violations of the soft constraints. There will be runs of two consecutive satellite-radio automobile bodies (which are small violations) spread throughout the sequence, but it will not produce longer runs (or larger violations) that are commonplace for PLC-based heuristics. From the perspective of scheduling additional manpower, this is much more preferable than the existing prior art, and is not likely to result in line temporary stoppages at normal staffing levels.

While the present invention has been described with help of an example with reference to generating a schedule for a set of events associated with an ASRS in an automobile manufacturing plant, it will be apparent to a person skilled in the art that the present invention can also be used to generate a schedule for events associated with other automata in industries such as:

1. Robots used to move wafers between processing stages in a semiconductor fabrication plant, including those in cluster tools. In a configuration of the cluster tool, robots move wafers between Front Opening Unified Pods (FOUPs) to load locks and then the wafers are moved to processing chambers in the cluster tool and back to the FOUP. FOUP is standard storage and transfer unit of wafers in a semiconductor manufacturing industry and the load lock is a process buffer area in which the wafers are moved from atmospheric pressure to vacuum, and from vacuum to atmospheric pressure. The actions of the robots such as loading a wafer from the load lock into the processing chamber, unloading a wafer from the load lock back to the FOUP are guided by an external controller. The external controller needs to respond to events such as FOUP arrivals, tool break downs, and the like, in real time. The present invention can be used to provide an optimal response to real-time events in terms of an optimal schedule for the robot actions. The optimization based on real-time event tracking will foresee, FOUP arrivals, and the like, to avoid scheduling/sequencing conflicts between the robot actions, thereby optimizing its movements to increase the throughput through the cluster tool;

2. Automated Material Handling Systems in a steel industry, for example, moving steel coils between various stages of processing such as cold rolling, tempering and annealing; and

3. Automated Storage and Retrieval Systems in food processing industries.

The system for generating/regenerating a schedule for a set of events, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer further comprises a microprocessor, which is connected to a communication bus. The computer also includes a memory, which may include Random Access Memory (RAM) and Read Only Memory (ROM). The computer system also comprises a storage device, which can be a hard disk drive or a removable storage drive such as a floppy disk drive, an optical disk drive, etc. The storage device can also be other similar means for loading computer programs or other instructions into the computer system. The computer system also includes a communication unit, which enables the computer to connect to other databases and the Internet through an Input/Output (I/O) interface. The communication unit also enables the transfer as well as reception of data from other databases. The communication unit may include a modem, an Ethernet card, or any similar device which enable the computer system to connect to databases and networks such as Local Area Network (LAN), Metropolitan Area Network (MAN), Wide Area Network (WAN) and the Internet. The computer system facilitates inputs from a user through an input device, accessible to the system through an I/O interface.

The computer system executes a set of instructions that are stored in one or more storage elements, in order to process the input data. The storage elements may also hold data or other information as desired. The storage element may be in the form of an information source or a physical memory element present in the processing machine.

The present invention may also be embodied in a computer program product for generating/regenerating a schedule for a set of events. The computer program product includes a computer usable medium having a set program instructions comprising a program code for generating/regenerating a schedule for a set of events. The set of instructions may include various commands that instruct the processing machine to perform specific tasks such as the steps that constitute the method of the present invention. The set of instructions may be in the form of a software program. Further, the software may be in the form of a collection of separate programs, a program module with a large program or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limit to these embodiments only. Numerous modifications, changes, variations, substitutions and equivalents will be apparent to those skilled in the art without departing from the spirit and scope of the invention, as described in the claims.

What is claimed is:

1. A method of regenerating a schedule of a set of events associated with at least one process of one or more processes in a manufacturing plant in real time, the method comprising:
a. monitoring an occurrence of each of one or more events associated with the one or more processes in real time, the set of events being at least one of the one or more events;
b. predicting an occurrence of each of the one or more events at one or more pre-defined instances of time, the prediction being based on one or more parameters associated with each of the one or more events, a current state of the monitored one or more events and a pre-defined criteria; and
c. optimizing the schedule in real time based on the predicted occurrence of the monitored one or more events, the optimization of the schedule being performed by optimizing an objective function associated with the schedule, the optimization of the objective function facilitating a regenerated schedule.

2. The method of claim 1 further comprising generating a first schedule of the set of events based on at least one of the predicted occurrence, an initial state of the monitored one or more events and the objective function.

3. The method of claim 1 further comprising characterizing each of the one or more events to be monitored in real time.

4. The method of claim 3, wherein each of the one or more events are characterized by a user.

5. The method of claim 3, wherein characterizing comprises defining the one or more parameters, the one or more parameters being defined by a user.

6. The method of claim 3, wherein characterizing further comprises assigning an importance level to the one or more events associated with the schedule, the importance level being assigned by a user.

7. The method of claim 1 further comprising defining the objective function based on one or more constraints associated with the manufacturing plant.

8. The method of claim 7 further comprising defining each of the one or more constraints, each of the one or more constraints being defined based on one or more requirements of the manufacturing plant.

9. The method of claim 8, wherein each of the one or more constraints are defined by a user.

10. The method of claim 7, wherein the one or more constraints are at least one of one or more hard constraints and one or more soft constraints, each of the one or more hard constraints and each of the one or more soft constraints affecting the feasibility of the schedule.

11. The method of claim 1 further comprising storing at least one of the initial state, the current state, the predicted occurrence of each of the one or more events at the one or more pre-defined instances of time, the one or more parameters and the objective function.

12. The method of claim 1, wherein regenerating the schedule further comprises optimizing the schedule based on an earlier schedule of the set of events, the earlier schedule being at least one of a first schedule and an earlier regenerated schedule.

13. The method of claim 12, wherein optimizing the schedule further comprises retaining the regenerated schedule close to the earlier schedule.

14. The method of claim 1, wherein an automaton is connected to the at least one process, the automaton being controlled by the schedule of the set of events.

15. A system for regenerating a schedule of a set of events associated with at least one process of one or more processes in a manufacturing plant in real time, the system comprising:
a. a monitoring module configured for monitoring an occurrence of each of one or more events associated with the one or more processes in real time, the set of events being at least one of the one or more events;
b. a prediction module configured for predicting an occurrence of each of the one or more events at one or more pre-defined instances of time, the prediction being based on one or more parameters associated with each of the one or more events, a current state of the monitored one or more events and a pre-defined criteria; and
c. a scheduling and sequencing module configured for optimizing the schedule in real time based on the predicted occurrence of the monitored one or more events, the optimization of the schedule being performed by optimizing an objective function associated with the schedule, the optimization of the objective function facilitating a regenerated schedule.

16. The system of claim 15 further comprising a user interface configured for enabling a user to characterize each of the one or more events to be monitored in real time.

17. The system of claim 16, wherein the user interface is further configured for enabling the user to define the one or more parameters.

18. The system of claim 16, wherein the user interface is further configured for enabling the user to assign an importance level to the one or more events associated with the schedule.

19. The system of claim 16 wherein the user interface is further configured for enabling the user to define the objective function based on one or more constraints associated with the manufacturing plant.

20. The system of claim 19, wherein the user interface is further configured for enabling the user to define each of the one or more constraints, each of the one or more constraints being defined based on one or more requirements of the manufacturing plant.

21. The system of claim 15 further comprising a memory module configured for storing at least one of the initial state, the current state, the predicted occurrence associated with each of the one or more events at one or more pre-defined instances of time, the one or more parameters and the objective function.

22. The system of claim 15, wherein the scheduling and sequencing module is further configured for generating a first schedule of the set of events based on at least one of the predicted occurrence, an initial state of the monitored one or more events and the objective function.

23. The system of claim 15, wherein the scheduling and sequencing module is further configured for optimizing the schedule based on an earlier schedule of the one or more events, the earlier schedule being at least one of a first schedule and an earlier regenerated schedule.

24. The system of claim 23, wherein the schedule module is further configured for optimizing the schedule to retain the regenerated schedule close to the earlier schedule.

25. The system of claim 15, wherein the system is integrated with and/or controls an automaton associated with the at least one process.

26. A computer program product for use with a computer, the computer program product comprising a computer usable medium having a computer readable program code embodied therein for regenerating a schedule of a set of events associated with at least one process of one or more processes in a manufacturing plant in real time, the computer readable program code performing:
a. monitoring an occurrence of each of one or more events associated with the one or more processes in real time, the set of events being at least one of the one or more events;
b. predicting an occurrence of each of the one or more events at one or more pre-defined instances of time, the prediction being based on one or more parameters associated with each of the one or more events, a current state of the monitored one or more events and a pre-defined criteria; and
c. optimizing the schedule in real time based on the predicted occurrence of the monitored one or more events, the optimization of the schedule being performed by optimizing an objective function associated with the schedule, the optimization of the objective function facilitating a regenerated schedule.

27. The computer program product of claim 26 further performing generating a first schedule of the set of events based on at least one of the predicted occurrence, an initial state of the monitored one or more events and the objective function.

28. The computer program product of claim 26, wherein each of the one or more events to be monitored in real time are characterized by a user.

29. The computer program product of claim 26, wherein the one or more parameters are defined by a user.

30. The computer program product of claim 26 further performing assigning an importance level to the one or more events associated with the schedule, the importance level being assigned by a user.

31. The computer program product of claim 26, wherein the objective function is defined by a user, the objective function being defined based on one or more constraints associated with the manufacturing plant.

32. The computer program product of claim 31, wherein each of the one or more constraints are defined by a user, the one or more constraints being defined based on one or more requirements of the manufacturing plant.

33. The computer program product of claim 26 further performing storing at least one of the initial state, the current state, the predicted occurrence of each of the one or more events at the one or more pre-defined instances of time, the one or more parameters and the objective function.

34. The computer program product of claim 26, wherein regenerating the schedule further comprises optimizing the schedule based on an earlier schedule of the set of events, the earlier schedule being at least one of a first schedule and an earlier regenerated schedule.

35. The computer program product of claim 34, wherein optimizing the schedule further comprises retaining the regenerated schedule close to the earlier schedule.
